(19) United States
(12) Patent Application Publication
(10) Pub. No.: US 2015/0339689 A1
(43) Pub. Date: Nov. 26, 2015

(54) SHOPPING TRAJECTORY

(71) Applicant: EBAY INC., San Jose, CA (US)

(72) Inventor: Hui-Min Chen, Pleasanton, CA (US)

(21) Appl. No.: 14/283,041

(22) Filed: May 20, 2014

(51) Int. Cl. G06Q 30/02

(52) U.S. Cl. CPC G06Q 30/0205; G06Q 30/0282

(57) ABSTRACT

Methods and systems for providing business information to a user or merchant, without revealing sensitive consumer or merchant information are described. A user/consumer or merchant/retailer sends a request for business information to a service provider. Business information includes, for example, customer location, customer feedback, customer spending behavior, volume of purchases, and retailers visited. The service provider receives the request and accesses its database to aggregate the business information. A graph, chart, or list of the business information is then provided to the user and/or merchant.

### BACKGROUND

1. Field of the Invention

The present invention generally relates to providing business information to consumers and merchants.

2. Related Art

Consumers often waste time attempting to search for popular products or services online when they arrive in a new location. It can be frustrating to sort through and process numerous comments and ratings of different retailers to figure out the most popular items and stores. In addition, it is unclear whether the reviewers are trustworthy. On the retailer side, merchants have been unable to gain access to an abundance of information associated with their customers and their industry. Thus, merchants typically cannot assess their performance in comparison to the performance of their competitors. It would therefore be beneficial to provide business information to both consumers and merchants.

### BRIEF DESCRIPTION OF THE FIGURES

FIG. 1 is a block diagram illustrating a system for providing business information according to an embodiment of the present disclosure;

FIG. 2 is a flowchart showing a method for providing business information according to an embodiment of the present disclosure;

FIG. 3 is a screenshot of a sales display filter page according to an embodiment of the present disclosure;

FIG. 4 is a screenshot displaying sales volume in graph form for merchants according to an embodiment of the present disclosure;

FIG. 5 is a screenshot displaying sales volume in list form according to an embodiment of the present disclosure;

FIG. 6 is a screenshot displaying customer feedback in graph form for merchants according to an embodiment of the present disclosure;

FIG. 7 is a screenshot of a feedback display filter page according to an embodiment of the present disclosure;

FIG. 8 is a screenshot displaying customer feedback in list form according to an embodiment of the present disclosure; and

FIG. 9 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that present business information to consumers and merchants, without providing customer or merchant confidential information. Such confidential information includes both customer and merchant information. Customer information may include identity and contact information. Merchant information may include actual sales volumes or total transaction dollar amounts. Instead of providing the real numbers and dollar amounts, the systems and methods described show relative numbers and amounts, In this way, confidential information is kept private, but merchants and consumers alike can still benefit from the information.

A user/consumer or merchant/retailer sends a request for business information to a service provider. Business information includes, for example, customer location, customer feedback, customer spending behavior, volume of purchases, and retailers visited. The request usually includes location information. The service provider receives the request and accesses its database to aggregate the business information based on location. A visual representation of the business information is then provided to the user and/or merchant. For example, a merchant can understand how many local potential buyers are in the area and offers can be presented to these local buyers in real time. A user can see popular local merchants and relative volume of their sales based on a specific item.

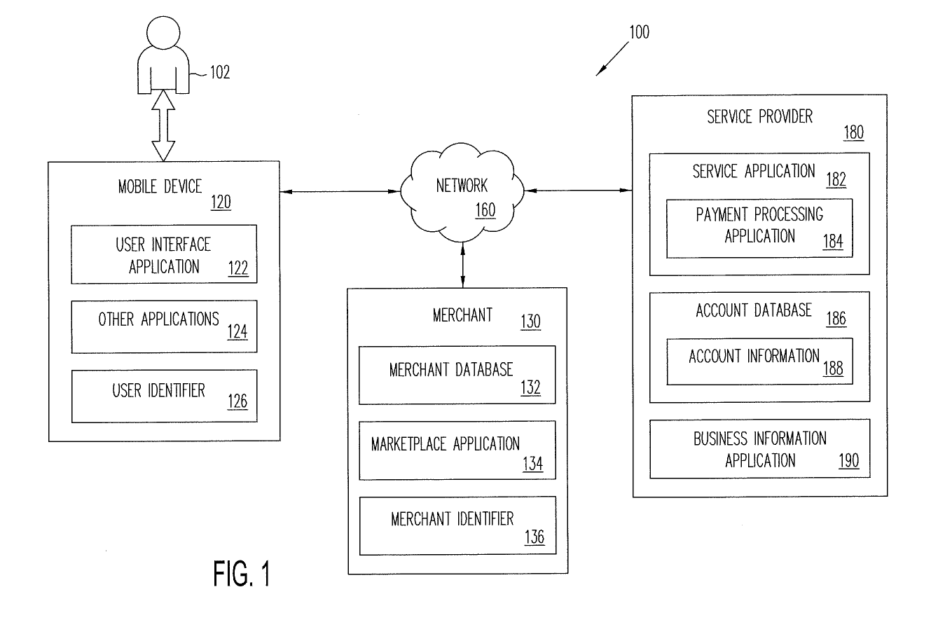

FIG. 1 shows one embodiment of a block diagram of a network-based system 100 adapted to provide business information over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), a merchant server or device 130, and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The mobile device 120, in various embodiments, may be implemented using any appropriate combination of hardware and/or software configured for wired and/or wireless communication over the network 160. The mobile device 120, in one embodiment, may be utilized by the user 102 to interact with the service provider server 180 over the network 160. For example, the user 102 may conduct financial transactions (e.g., account transfers, bill payment, etc.) with the service provider server 180 via the mobile device 120. In various implementations, the mobile device 120 may include a wireless telephone (e.g., cellular or mobile phone), a tablet, a wearable computing device, a personal computer, a notebook computer, and/or various other generally known types of wired and/or wireless computing devices.

The mobile device 120, in one embodiment, includes a user interface application 122, which may be utilized by the user 102 to conduct transactions (e.g., shopping, purchasing, bidding, etc.) with the merchant device 130 or the service provider server 180 over the network 160. In one aspect, purchase expenses may be directly and/or automatically debited from an account related to the user 102 via the user interface application 122. The user interface application 122, in various embodiments, also displays business information to the user 102.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The mobile device 120, in one embodiment, includes a geo-location component adapted to monitor and provide an instant geographical location (i.e., geo-location) of the mobile device 120. In one implementation, the geo-location of the mobile device 120 may include global positioning system (GPS) coordinates, zip-code information, area-code information, street address information, and/or various other generally known types of geo-location information. In one example, the geo-location information may be directly entered into the mobile device 120 by a user via a user input component, such as a keyboard, touch display, and/or voice recognition microphone. In another example, the geo-location information may be automatically obtained and/or provided by the mobile device 120 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In one aspect, when interfacing with the mobile device 120, the user 102 may elect to provide or may be prompted to provide permission for the release of geo-location information. Accordingly, the user 102 may have exclusive authority to allow transmission of geo-location information from the mobile device 120 to the service provider server 180. In any instance, the service provider server 180 may communicate with the mobile device 120 via the network 160 and request permission to acquire geo-location information from the mobile device 120 for geo-location based commerce.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identifying items for sale, which may be made available to the mobile device 120 for viewing and purchase by the user 102. In one or more embodiments, user 102 may complete a transaction such as purchasing the items via the service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of service provider as a payment intermediary. The merchant website may also have an account with the service provider.

The service provider server 180, in one embodiment, may be maintained by a transaction processing entity, which may provide processing for financial transactions and/or information transactions between the user 102 and merchant server 130. As such, the service provider server 180 includes a service application 182, which may be adapted to interact with the mobile device 120 and/or the merchant server 130 over the network 160. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service provider server 180, in one embodiment, may be configured to maintain one or more user accounts and merchant accounts in an account database 186 each of which may include account information 188 associated with one or more individual users (e.g., user 102) and merchants (e.g., merchant associated with merchant server 130). For example, account information 188 may include private financial information of user 102, such as one or more account numbers, passwords, credit card information, banking information, or other types of financial information, which may be used to facilitate financial transactions between user 102 and a merchant. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes business information application 190. Business information application 190 gathers business information from financial transactions between consumers and merchants (e.g., merchant associated with merchant server 130). The business information may be collected or otherwise stored for individuals who have conducted a transaction online or at a brick and mortar merchant location. Business information may be gathered during a relationship between a consumer and the service provider. Such information may include consumer demographic information, such as user name, address, telephone number, email address, and social security number. Business information can also include consumer transactional data, consumer spending behavior, or any data pertaining to the particular transactions in which a consumer engages during any given time period. Consumer transactional data may include, for example, transaction amount, transaction item, transaction time, transaction merchant, and transaction merchant location. Transaction merchant location may contain a high degree of specificity to a merchant. For example, transaction merchant location may include a particular gasoline station in a particular postal code location at a particular cross section or address.

The business information application 190 also aggregates and displays business information to a consumer and/or merchant. For example, the application 190 can collect and combine data for donut shops in a particular geographic location. The data can relate to how many donuts are sold in a day for each shop, what type of donuts are the most popular for each shop, and good/neutral/bad reviews for each donut shop. The data for each donut shop can then be displayed as a graph or chart, and the user 102 or a merchant can see how the donut shops compare to each other.

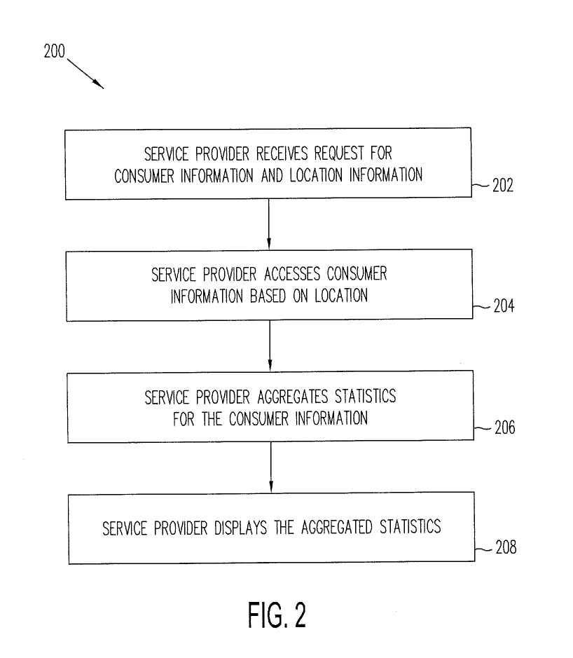

Referring now to FIG. 2, a flowchart 200 of a method for providing business information is illustrated according to an embodiment of the present disclosure. The user 102 arrives at a location, decides he or she wants to go shopping, and wants to find out the most popular places to shop. The user 102 submits a request for business information to the service provider server 180 and provides his or her location information to the service provider. In various embodiments, the user 102 specifies the kind of business information he or she wants.

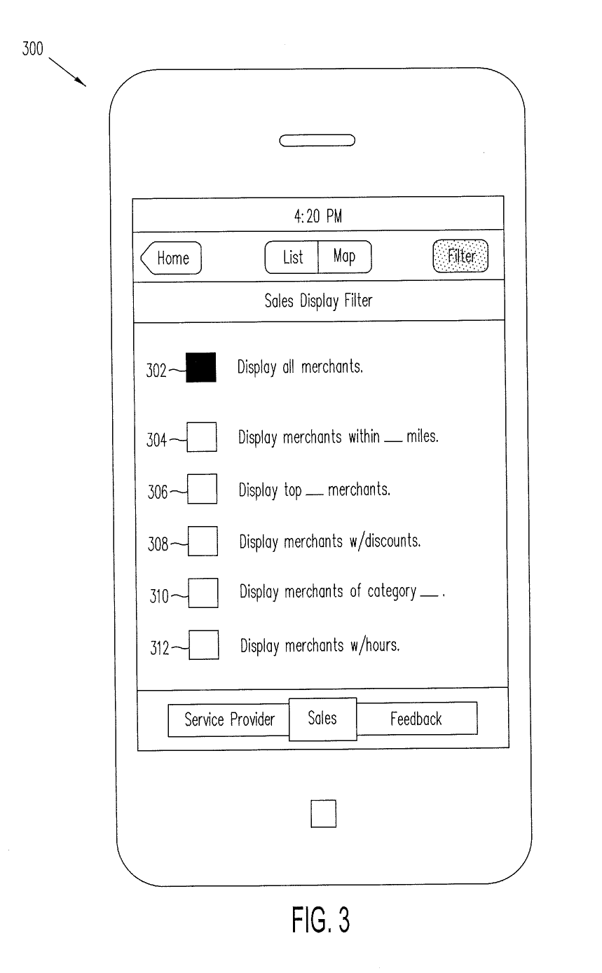

For example, FIG. 3 is a screenshot 300 of a “Sales Display Filter” page (e.g., what the user 102 sees when he or she selects the “Filter” tab while in the “Sales” mode). As shown, the user 102 can select to display all merchants 302. The user 102 can narrow the search criteria based on distance 304, popularity 306, merchants with discounts 308, merchant category 310, or merchant store hours 312. The user 102 may also specify a time limitation. For example, the searches may be limited to transactions occurring within the past 6 months or 12 months. Limiting the transaction time period maintains the relevancy of the results. At step 202, the service provider server 180 receives the request and location of the user 102.

At step 204, the service provider server 180 accesses business information from its account database 186 based on the location of the user 102. For example, the service provider may retrieve information relevant to merchants within a certain radius of the user 102. Business information can include information on customer purchases (items bought), merchants visited, and customer feedback. Data related to merchants visited can include merchant name, merchant category, merchant location, transaction amount, transaction frequency, volume of items sold (both in unit and dollar amount), merchandise sold, and merchandise category.

At step 206, the service provider server 180 aggregates statistics for the business information. For example, the service provider can aggregate statistics for a single merchant, for a group of merchants that are close to each other geographically, for specific merchandise, and/or for a particular merchandise category. In various embodiments, the service provider may analyze data to generate statistics, summaries, averages, trends, and/or other mathematical results related to the business information.

At step 208, the service provider server 180 displays the aggregated statistics to the user 102. In exemplary embodiments, the aggregated statistics are presented as a visual representation, such as in a graph or chart. The chart or graph may encompass a particular time period (e.g., one day, 2 weeks, 1 month, 6 months, 1 year, etc.) depending on the request. In some embodiments, there may be an option to view the graph or chart in association with a map.

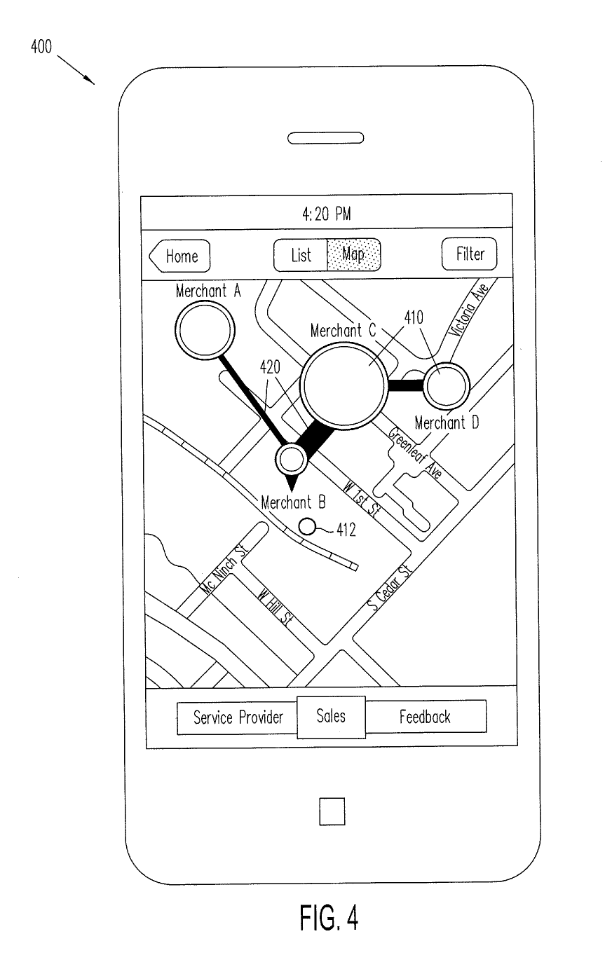

FIG. 4 illustrates a sample screenshot 400 of a graph displaying sales volume for a group of merchants (Merchants A, B, C, and D) that are close to each other geographically. The sales volume may relate to a specific item or may be the sales volume of all items sold by the merchant. As shown, the graph includes dots or nodes 410 at merchant locations close to location 412 of the user 102. The dots 410 indicate the volume of purchases made by consumers in the past at those merchant locations. The size of the dots varies, depending on transaction amounts. The larger the dot, the greater the volume of sales. Therefore, Merchant C is shown as having the greatest amount of sales, while Merchant B has the least.

Although not shown in FIG. 4, the color of the dots 110 can also vary. The color of the dots 110 can indicate the popularity of the merchant or the type of merchandise sold. For example, a color of red can indicate the most popular merchants in the area, a color of blue can indicate moderately popular merchants, and a color of yellow can indicate the least popular merchants. Popularity can be determined in any number of ways, including merchants having the most sales volume, highest dollar amount of sales, largest number of visitors, largest number of customers (visitors who made a purchase), longest average times a visitor or a customer spends at a merchant, and other objective measurements. Popularity can also be determined based on user preferences, such that one merchant may be more popular with one user than with another user. For example, such user-based popularity measurements may be based on user spending habits (a thrift store may be more popular to a user who buys more generic or discounted items than a user who buys mostly name-brand luxury goods) or types of goods the user typically purchases. An orange colored dot can indicate a surf shop, a green colored dot can indicate a restaurant, a purple colored dot can indicate a flower shop, and black colored dot can indicate a jewelry store.

Referring back to FIG. 4, two dots 410 may be connected through a link 420. The link 420 shows that at least one consumer has shopped at the two dots 410 in the past. For example, the link 420 connecting Merchant A to Merchant B shows that consumers have visited both merchants. The thickness of the link 420 reflects the amount of consumers who purchased from both merchants or the relative frequency of co-purchases in the past. As shown, the link 420 connecting Merchant B to Merchant C is thicker than the link 420 connecting Merchant A to Merchant B, or the link 420 connecting Merchant C to Merchant D. The thicker link indicates that there were more consumers who purchased from both Merchant B and Merchant C than from Merchant A and Merchant B or Merchant C and Merchant D (or that consumers bought more frequently from Merchant A and Merchant B).

Although not shown in FIG, 4, different colors can also be used to show the frequency of co-purchases in the past. For example, a red colored link 420 can indicate a higher occurrence of consumers making co-purchases than a green colored link. In some embodiments, numbers are placed on the dots 410, where the numbers indicate the order that most consumers take in visiting the different merchants. For example, the dot 410 for Merchant A can have a 3, Merchant B can have a 1, Merchant C can have a 4, and Merchant D can have a 2. This shows that the majority of consumers who visited all four merchants visited Merchant B first, Merchant D second, Merchant A third, and Merchant C fourth.

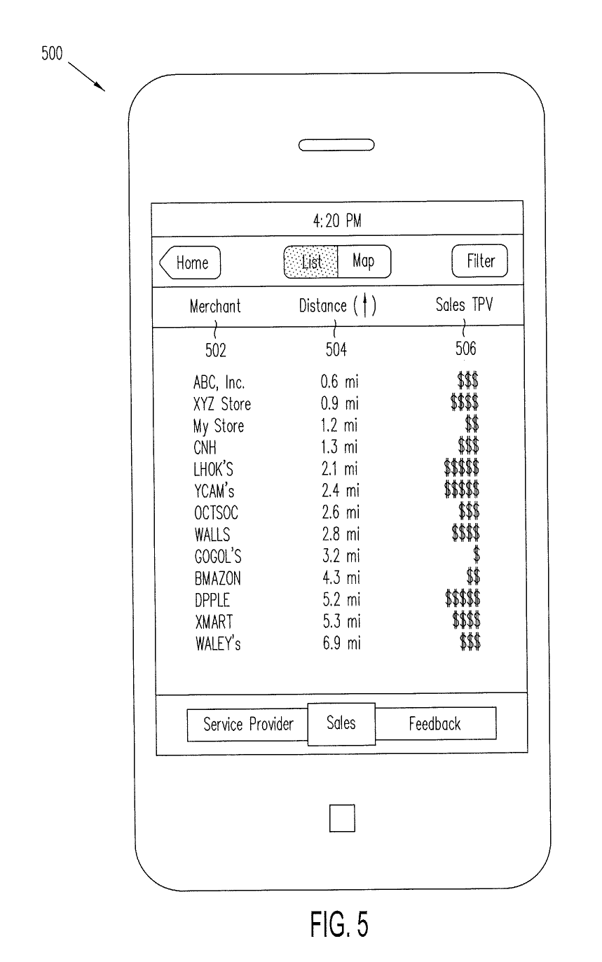

There may also be presented an option to view a list of the business information or more detailed information. These options may permit a merchant or a user to view detailed information about transaction activity or spend activity. FIG. 5 shows a sample screenshot 500 when the user 102 clicks on the “List” tab while in the “Sales” mode. As shown, the names of the different merchants 502, specific numerical distance 504 from the user 102, and relative sales volume 506 are displayed in list form, rather than in a chart or graph. Advantageously, the actual numbers of sales are not provided, but the dollar signs indicate the relative sales numbers.

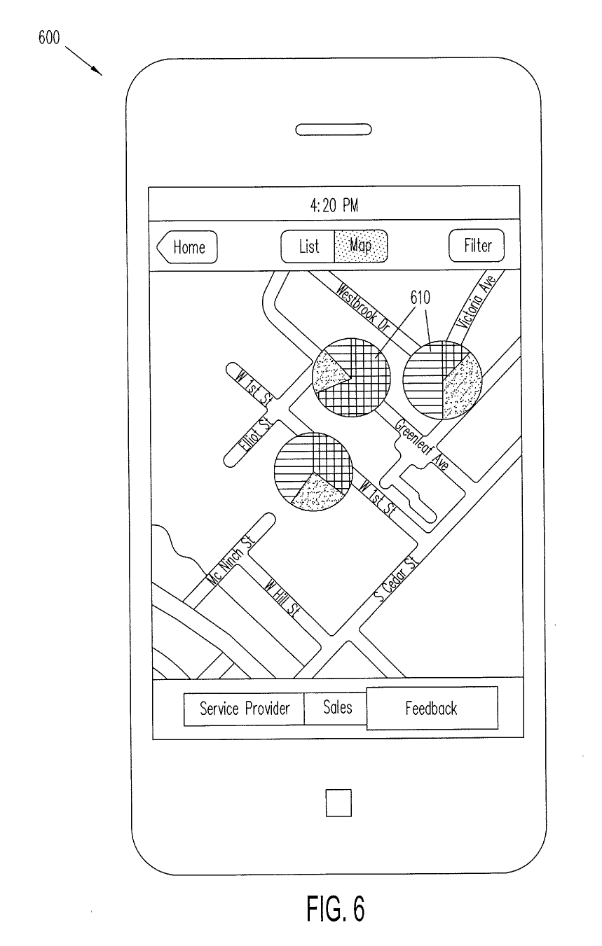

Turning now to FIG. 6, a sample screenshot 600 illustrates customer feedback for merchants. As shown, pie charts 610 indicating positive, negative, or neutral feedback are displayed for merchants that are close to each other. Different colors or different shadings can be used to designate a bad, good, or neutral review. For example, green can be used to show good reviews, blue to show neutral reviews, and red to show bad reviews.

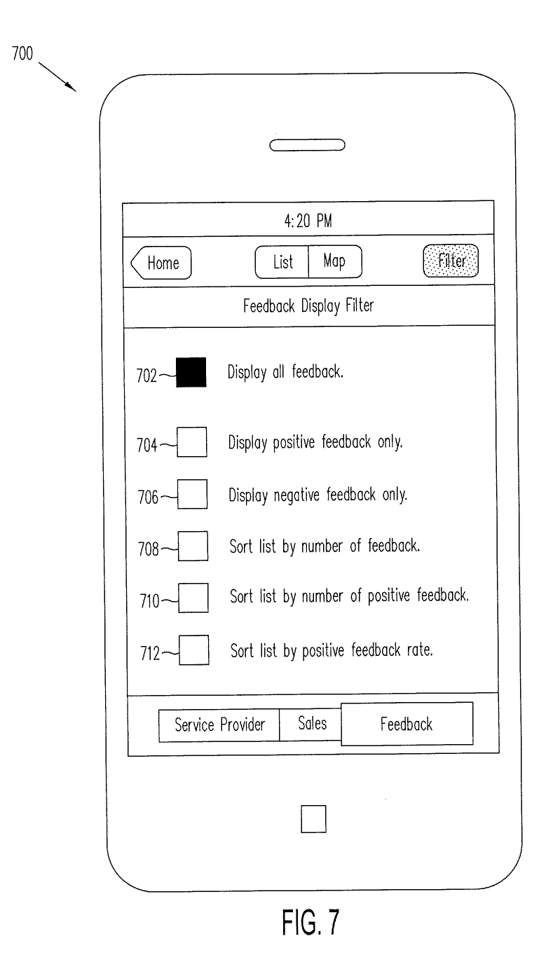

FIG. 7 shows a sample screenshot 700 of a “Feedback Display Filter” page (e.g., what the user 102 sees when he or she selects the “Filter” button while in the “Feedback” mode). The user 102 can select to have all feedback 702 shown. The user 102 can also narrow the search criteria so that only positive feedback 704 or negative feedback 706 is displayed. The user 102 may also choose to sort the list of merchants by amount of feedback 708, amount of positive/negative feedback 710, or positive/negative feedback rate 712. The user 102 may also specify a time limitation.

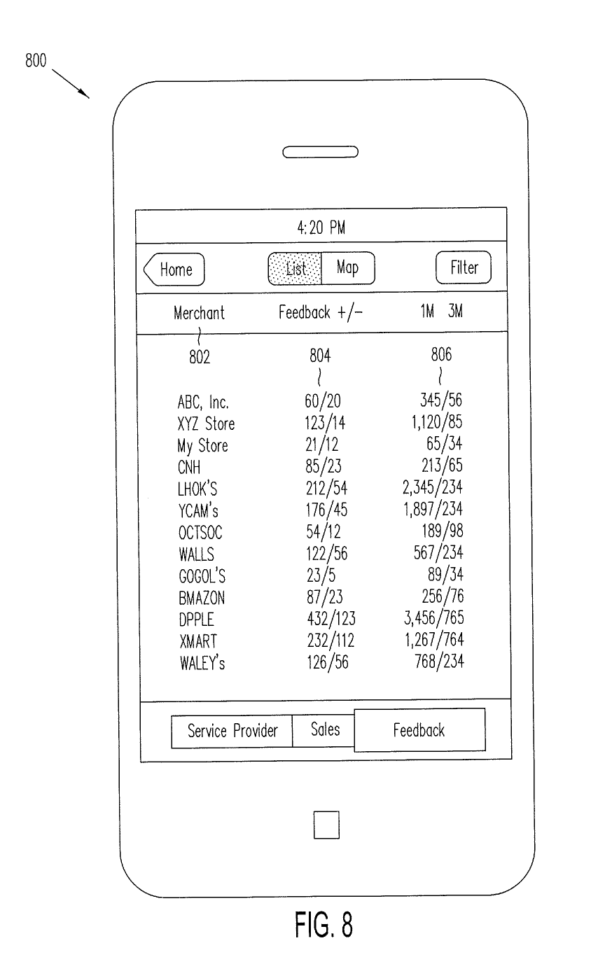

FIG. 8 illustrates a sample screenshot 800 when the user 102 clicks on the “List” tab while in the “Feedback” mode. As shown, the names of the different merchants 802 are displayed, along with the positive/negative feedback in the past month 804 and the negative/positive feedback in the past 3 months 806.

Although FIG. 2 is discussed primarily with respect to a user/consumer, it should be understood that a merchant/retailer can also make requests for and view business information. A merchant can specify a particular location (although the merchant is not required to do so) that should be analyzed and request business information related to a specific merchant, a group of merchants that are close to each other geographically, for specific merchandise, or for a particular merchandise category. The service provider can display aggregated statistical data to the merchant. When a merchant selects a map option, a map showing the highest ranked merchant location or group of merchant locations may be displayed. In various embodiments, a percentage of returning customers to a specific merchant location may be displayed together with a percentage of new customers, and these percentages may be displayed in a pie chart, bar chart, and/or any other of the myriad graphical/numerical modes of representation that are available.

Like a user, the merchant may specify certain search criteria for the business information. For example, the merchant may only want to know information related to consumers that live in a certain area, spend a certain amount of money, buy certain merchandise, or buy items for a certain merchandise category. The service provider can take the statistics for that category of consumers, aggregate the data, and present the aggregated data to the merchant. The aggregated data can provide insight into the current spending of a merchant's customers and their competitors' customers. The data may be used by a merchant to assess a large variety of factors affecting their sales, ranging from poor sales at a particular location to improved sales over a particular year. The data with which the service provider generates the results are unique in that they are largely unavailable to merchants. The service provider provides a diverse and powerful range of business insights based on its unique access to a large variety of data.

In various embodiments, the merchant may be interested in knowing how many consumers are in the vicinity of a merchant location, i.e., within a specific radius of a retail store. The service provider may show the number of active service provider users in a geographic location historically or in real-time. A local service provider user may be considered active if his or her smartphone or mobile device has synced up with the service provider server 180 in the past few hours. Merchants can then submit real-time offers (deals, coupons, promotions, etc.) and services to buyers that are nearby. These offers can be forwarded to the buyers by the service provider server 180. The offers and services may be made available by a plurality of merchants to increase customer base, reward loyal customers, increase brand recognition, and the like.

Advantageously, the present disclosure provides an easy mechanism to share data in a format that does not reveal sensitive information. No confidential or actual information is provided to either the user 102 or the merchant. The service provider does not disclose user information (identity, contact information, etc.) to any parties because the service provider provides anonymity to buyers. The actual sale volumes and the total transaction amount of any retailer are not shown to any parties.

A user/consumer benefits from the aggregated information in many ways. A consumer can easily identify the most popular local retailer and merchandise. A consumer can get a taste of relative strength or specialty of a local retailer. A consumer can compare two or more local retailers in terms of travel distance, relative sale volume, and relative customer feedback score. A consumer can get an idea where the local retailers are based on the map, how to get there, and plan the best route to visit the retailers.

A merchant/retailer also benefits from the aggregated information in many ways. The information provides an overview of relative sales volume, customer feedback, and traffic flow among retailers in a geographic location. A retailer gets an idea regarding local buyers' shopping preferences.

In addition, merchants benefit from being able to understand their customers or potential customers, without having to rely on personally identifiable information. Merchants can perform competitive analysis and offer rewards to customers. The service provider mines financial transaction data to enable a more complete view of customer spending including trends in customer purchases including most recent merchant and category preferences, and the like. The service provider develops a model of customer spending habits including category preferences, geographic locations, periodic purchases, etc.

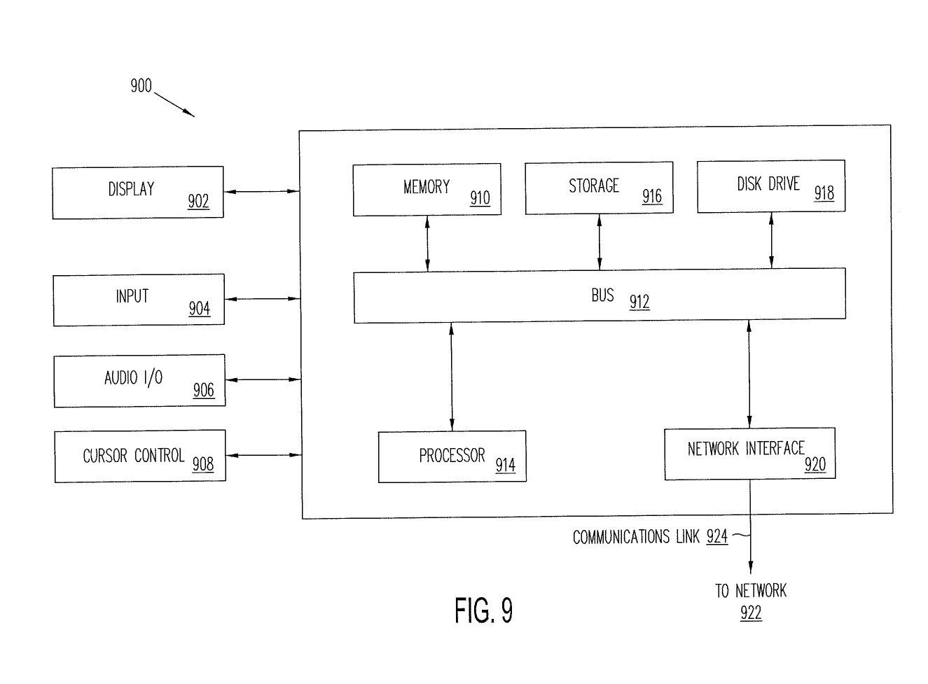

FIG. 9 is a block diagram of a computer system 900 suitable for implementing one or more embodiments of the present disclosure, including the mobile device 120, the merchant device or server 130, and the service provider server 180. In various implementations, the mobile device 120 may comprise a mobile cellular phone, personal computer (PC), laptop, wearable computing device, etc. adapted for wireless communication, and the merchant server or device 130 and service provider server 180 may comprise a network computing device, such as a server. Thus, it should be appreciated that the devices 120, 130, and 180 may be implemented as computer system 700 in a manner as follows.

Computer system 900 includes a bus 912 or other communication mechanism for communicating information data, signals, and information between various components of computer system 900. Components include an input/output (I/O) component 904 that processes a user action, such as selecting keys from a keypad/keyboard, selecting one or more buttons or links, etc., and sends a corresponding signal to bus 912. I/O component 904 may also include an output component, such as a display 902 and a cursor control 908 (such as a keyboard, keypad, mouse, etc.). An optional audio input/output component 906 may also be included to allow a user to use voice for inputting information by converting audio signals. Audio I/O component 906 may allow the user to hear audio. A transceiver or network interface 920 transmits and receives signals between computer system 900 and other devices, such as another user device, a merchant server, or a service provider server via a network 922 (such as network 160 of FIG. 1). In one embodiment, the transmission is wireless, although other transmission mediums and methods may also be suitable. A processor 914, which can be a micro-controller, digital signal processor (DSP), or other processing component, processes these various signals, such as for display on computer system 700 or transmission to other devices via a communication link 924. Processor 914 may also control transmission of information, such as cookies or IP addresses, to other devices.

Components of computer system 900 also include a system memory component 910 (e.g., RAM), a static storage component 916 (e.g., ROM), and/or a disk drive 918. Computer system 900 performs specific operations by processor 914 and other components by executing one or more sequences of instructions contained in system memory component 910. Logic may be encoded in a computer readable medium, which may refer to any medium that participates in providing instructions to processor 914 for execution. Such a medium may take many forms, including but not limited to, non-volatile media, volatile media, and transmission media. In various implementations, non-volatile media includes optical or magnetic disks, volatile media includes dynamic memory, such as system memory component 910, and transmission media includes coaxial cables, copper wire, and fiber optics, including wires that comprise bus 912. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 924 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing business information; and
one or more processors in communication with the memory device and operable to:
receive location information;
aggregate business information based on the location; and
display the aggregated business information without revealing actual sales amounts or total transaction amounts of merchants.

2. The system of claim 1, wherein the business information is aggregated for a single merchant, group of merchants, a type of merchandise, a merchandise category, or any combination thereof.

3. The system of claim 1, wherein the aggregated business information is displayed as a graph or chart.

4. The system of claim 3, wherein the graph or chart is placed on a map.

5. The system of claim 4, wherein the graph or chart includes dots that represent merchant locations.

6. The system of claim 5, wherein the color of the dots indicate popularity of the merchant or type of merchandise.

7. The system of claim 5, wherein two dots are connected by a link, and a thickness of the link indicates the number of consumers who purchased items from the two merchant locations associated with the two dots or the thickness indicates relative frequency of past co-purchases.

8. A method for providing business information to a user, comprising:
receiving, by one or more hardware processors, a location of the user;
receiving, by the one or more hardware processors, search criteria from the user;
aggregating, by the one or more hardware processors, the business information based on the search criteria and location of the user; and
displaying, by the one or more hardware processors, the aggregated business information without revealing actual sales amounts or total transaction amounts of merchants.

9. The method of claim 8, wherein the search criteria comprises one or more of distance, time, popularity, merchant hours, merchant discounts, and merchant category.

10. The method of claim 8, wherein the aggregated business information comprises customer feedback.

11. The method of claim 10, further comprising receiving, from the user, search criteria for the customer feedback.

12. The method of claim 10, wherein the customer feedback is displayed as a pie chart with different colors or patterns indicating positive, neutral, or negative feedback.

13. The method of claim 8, wherein the aggregated business information is displayed as a list.

14. A non-transitory machine-readable medium comprising instructions which, in response to a computer system, cause the computer system to perform a method comprising:
aggregating business information based on a request from a merchant; and
displaying the aggregated business information without revealing actual sales amounts of merchants, total transaction amounts of merchants, consumer identities, or consumer contact information.

15. The non-transitory machine-readable medium of claim 14, wherein the method further comprises receiving search criteria from the merchant.

16. The non-transitory machine-readable medium of claim 15, wherein the search criteria comprises one or more of where consumers live, how much consumers spend, and what consumers buy.

17. The non-transitory machine-readable medium of claim 14, wherein the business information comprises consumer location.

18. The non-transitory machine-readable medium of claim 17, wherein the aggregated business information comprises a number of consumers in a certain area.

19. The non-transitory machine-readable medium of claim 18, wherein the method further comprises forwarding real-time offers from the merchants to the consumers.

20. The non-transitory machine-readable medium of claim 14, wherein the aggregated business information is displayed as a graph, chart, or list.
